(19) United States
(12) Patent Application Publication
(10) Pub. No.: US 2021/0201346 A1
(43) Pub. Date: Jul. 1, 2021

(54) Platform for Optimization and Personalization of Existing Communication Channels

(71) Applicant: CloudNCo, Inc. dba NextUser, San Francisco, CA (US)

(72) Inventor: Matthieu Dejardins, San Francisco, CA (US)

(21) Appl. No.: 17/180,166

(22) Filed: Feb. 19, 2021

Related U.S. Application Data
(63) Continuation-in-part of application No. 14/276,971, filed on May 13, 2014, now abandoned.

(51) Int. Cl. G06Q 30/02; H04L 12/58; H04L 29/08; G06F 16/951

(52) U.S. Cl. CPC G06Q 30/0244; H04L 51/26; H04L 67/306; H04L 51/36; G06N 20/00; G06F 16/951; G06Q 30/0269; G06Q 30/0254; H04L 51/16

(57) ABSTRACT

Provided are methods and systems for optimization and personalization of existing communication channels. An example method commences with aggregating user data received from a plurality of data sources and creating a user profile for a user associated with the user data. The method includes creating a business logic for user interactions of the user via the existing communication channels. The business logic includes trigger conditions and actions corresponding to the trigger conditions. The method continues with mapping, using a recommendation algorithm, content to the user according to the business logic. The content is templatized to create personalized communication messages for the existing communication channels. The method includes receiving feedback data in response to the user interactions with the personalized communication messages. Based on the feedback data, the user profile is updated, and the recommendation algorithm and the next suggestion communication action are updated based on the updated user profile.

### CROSS REFERENCE TO RELATED APPLICATIONS

The present application is a continuation-in-part of U.S. application Ser. No. 14/276,971, filed on May 13, 2014 and titled “Delivering Personalized User Experiences via an Array of Channels Based on Collected User Data and Customizable Business Rules,” the subject matter of which is incorporated herein by reference for all purposes.

### TECHNICAL FIELD

This application relates generally to data processing and, more specifically, to optimization and personalization of existing communication channels.

### BACKGROUND

The approaches described in this section could be pursued but are not necessarily approaches that have been previously conceived or pursued. Therefore, unless otherwise indicated herein, the approaches described in this section are not prior art to the claims in this application and are not admitted to be prior art by inclusion in this section.

Businesses can communicate with their customers or potential customers via multiple communication channels such as web sites, mobile applications, emails, social network pages, Short Message Service (SMS), push notifications, customer support tickets, chat bots, and so forth. However, conventional systems lack the capability for optimizing and personalizing unified content delivered to customers across multiple communication channels/systems. Typically, there can be 5 to 9 data and communication systems per company.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an example embodiment, a system for optimization and personalization of a plurality of existing communication channels is provided. The system may include a data aggregation module, a communication channel orchestration interface, and a content mapping and individualization module. The aggregation module may be configured to aggregate user data received from a plurality of data sources. The user data may be associated with at least one user. The user may include a known user or a new user. The aggregation module may be further configured to create at least one user profile for the at least one user based on the aggregated user data. The aggregation module is configured by default to receive feedback data in response to user interactions with the personalized communication messages, update the at least one user profile with the feedback data, and update a recommendation algorithm and next suggested communication actions based on the at least one updated user profile.

The communication channel orchestration interface may be configured to create a business logic for the user interactions of the at least one user via the plurality of existing communication channels. The business logic may include a plurality of trigger conditions and a plurality of actions corresponding to the plurality of trigger conditions. The content mapping and individualization module may be configured to map content to the at least one user according to the business logic using the recommendation algorithm. The content may be templatized to create personalized communication messages for the plurality of existing communication channels, data sources, and content.

According to another embodiment, a method for optimization and personalization of a plurality of existing communication channels is provided. The method may commence with aggregating user data received from a plurality of data sources. The user data may be associated with at least one user. Upon aggregating the user data, at least one user profile is created for the at least one user based on the aggregated user data. The method may further include creating a business logic for user interactions of the at least one user via the plurality of existing communication channels. The business logic may include a plurality of trigger conditions and a plurality of actions corresponding to the plurality of trigger conditions. The method may continue with mapping content to the at least one user according to the business logic and using a recommendation algorithm. The content may be templatized to create personalized communication messages for the plurality of existing communication channels. The method includes receiving feedback data in response to the user interactions with the personalized communication messages. Based on the feedback data, the at least one user profile may be updated, and the recommendation algorithm and a next suggestion communication action may be updated based on the updated at least one user profile.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example and not limitation in the figures of the accompanying drawings, in which like references indicate similar elements.

FIG. 1 is a block diagram of an environment, in which systems and methods for optimization and personalization of a plurality of existing communication channels can be implemented, according to some example embodiments.

FIG. 2 is a high-level block diagram illustrating an architecture within which elements of a system for optimization and personalization of a plurality of existing communication channels, a plurality of data sources, and a plurality of content may be implemented.

FIG. 3 is a schematic diagram illustrating operation of a system for optimization and personalization of a plurality of existing communication channels, according to an example embodiment.

FIG. 4 is a schematic diagram showing key components of a system for optimization and personalization of a plurality of existing communication channels, according to an example embodiment.

FIG. 5 is a schematic diagram showing key components included into a data aggregation module, according to an example embodiment.

FIG. 6 is a schematic diagram showing key components included into a data aggregation module associated with both quantitative information (left) and qualitative information such as Artificial Intelligence (right), according to an example embodiment.

FIG. 7 is a schematic diagram showing key components included into a data aggregation module associated with Artificial Intelligence, according to an example embodiment.

FIG. 8 is a schematic diagram showing steps performed by a communication channel orchestration interface, according to an example embodiment.

FIG. 9 is a schematic diagram showing all the existing communication channels managed by a content mapping and individualization module, according to an example embodiment.

FIG. 10 is a flow diagram that shows a method for optimization and personalization of a plurality of existing communication channels, according to an example embodiment.

FIG. 11 is a diagrammatic representation of an example machine in the form of a computer system within which a set of instructions for the machine to perform any one or more of the methods discussed herein is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The present disclosure provides systems and methods for optimization and personalization of a plurality of existing communication channels. The systems and methods can be used by companies and brands to personalize content the companies and brands deliver to their users across the plurality of existing communication channels. The systems and methods can include three layers, specifically, data aggregation, orchestration of communication channels, and personalization of the content sent to the user. Thus, an example system for optimization and personalization of a plurality of existing communication channels may include a data aggregation module that dynamically aggregates user data received from a plurality of data sources, such as personal data, history data, social network data, user navigation history, and so forth. Using the collected data, the data aggregation module may provide a view of online traffic across multiple online communication channels of the company such as, for example, web sites or mobile applications. The collected and aggregated data may be used to unify data related to the same user and store the unified data to a user profile created by the system.

The system may further include a communication channel orchestration interface configured to create a business logic for the user interactions via the plurality of existing communication channels. The communication channel orchestration interface may be configured to manage and orchestrate the existing communication channels. The business logic may include trigger conditions and actions corresponding to the trigger conditions. The trigger condition may include, for example, a communication channel preferred by the user, communication channel used by the user, current location of the user, current time, period of day the user usually uses the communication channel, and so forth.

The system may further include a content mapping and individualization module configured to adapt communication messages to the user according to a predetermined business logic. The content mapping and individualization module may use a recommendation algorithm configured to select and personalize the content for the user based on the user data. Specifically, the content may be templatized to create personalized communication messages for the existing communication channels. The content may be delivered to the user as personalized communication messages via one or more communication channels selected using the business logic based on the user data and user interactions with the existing communication channels.

The system may continuously receive feedback data related to user interactions with the personalized communication messages and update the user profile and the recommendation algorithm and a next suggestion communication action based on the feedback data.

The system may be connected to existing communication channels (e.g., a website, a mobile application, and so forth) of a company and individuals and may provide an interface enabling an employee of a company (e.g., a marketer) or an individual in a different role to create, edit, or otherwise customize business workflows, rules, criteria, and other parameters associated with the existing communication channels.

The system can provide personalized user experience for users by presenting content personalized specifically for each user based on data associated with that user. The personalized content can be delivered to the user via one or more of multiple communication channels where one or more of the communication channels is specifically selected for the user based on the collected user data. Thus, the content personalized specifically for each user can be delivered using the communication channel selected as the most personalized communication channel for communications with a specific user. Accordingly, the systems and methods of the present disclosure provide an advantageous solution that can be used by a company to respond to users of multiple systems of the company (e.g., a website, a mobile application, a social network account, an offline shop) and engage end users across multiple commutation channels.

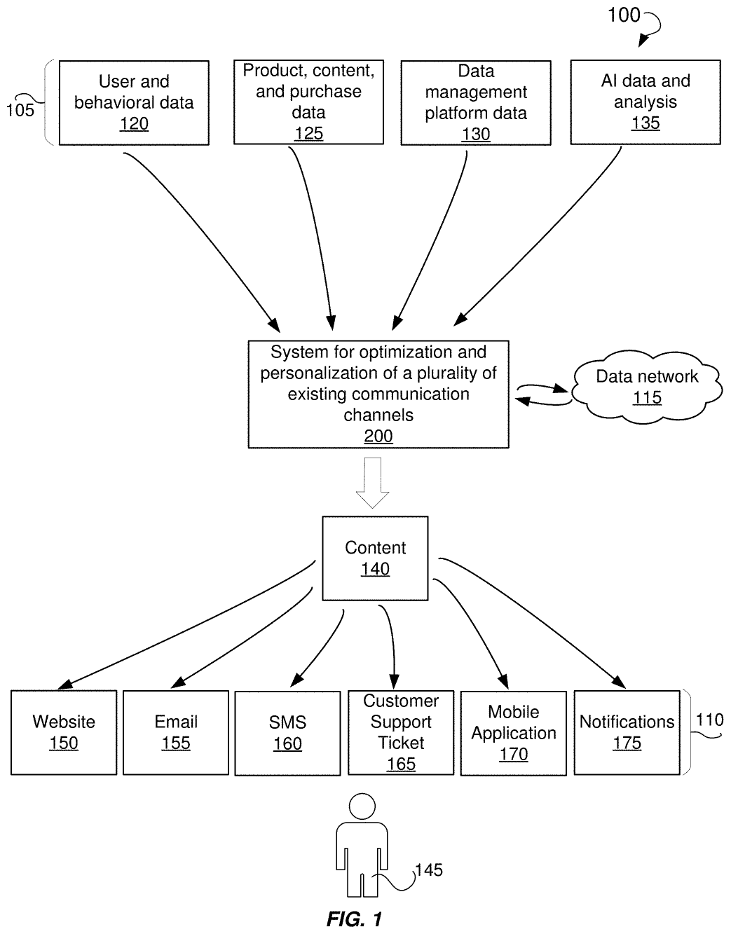

Referring now to the drawings, FIG. 1 is a block diagram of environment 100, in which systems and methods for optimization and personalization of a plurality of existing communication channels can be implemented, according to some example embodiments. The environment 100 may include a system 200 for optimization and personalization of a plurality of existing communication channels, data sources 105, communication channels 110, and data network 115. The data sources 105 may provide user data and data related to user behavior shown as user and behavioral data 120, product, content, and purchase data 125, data management platform data 130, artificial intelligence (AI) data and analysis 135, and other data sources. The system 200 may collect user data from the data sources 105, aggregate the user data, and attribute user data related to the same user to a user profile created for a particular user 145 by the system 200. The system 200 may use the user data to create content 140 personalized for the user 145 based on the user data.

The system 200 may further orchestrate multiple communication channels 110. The communication channels 110 may include a website 150, an email 155, an SMS 160, a customer support ticket 165, a mobile application 170, notifications 175, and so forth. The system 200 may create a business logic for the user interactions of the user 145 via the communication channels 110 by creating a plurality of trigger conditions and a plurality of actions corresponding to the plurality of trigger conditions.

The system 200 may adapt the content 140 to the user 145 according to the business logic in a form of personalized communication messages. The personalized communication messages may be delivered to the user 145 using one or more of the communication channels 110 selected based on the business logic.

The system 200 may communicate with the data sources 105 and communication channels 110 via the data network 115. The data network 115 may include the Internet or any other network capable of communicating data between devices. Suitable networks may include or interface with any one or more of, for instance, a local intranet, a corporate data network, a data center network, a home data network, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network 115 can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus (USB) connection or other wired or wireless, digital, or analog interface or connection, mesh, or Digi® networking.

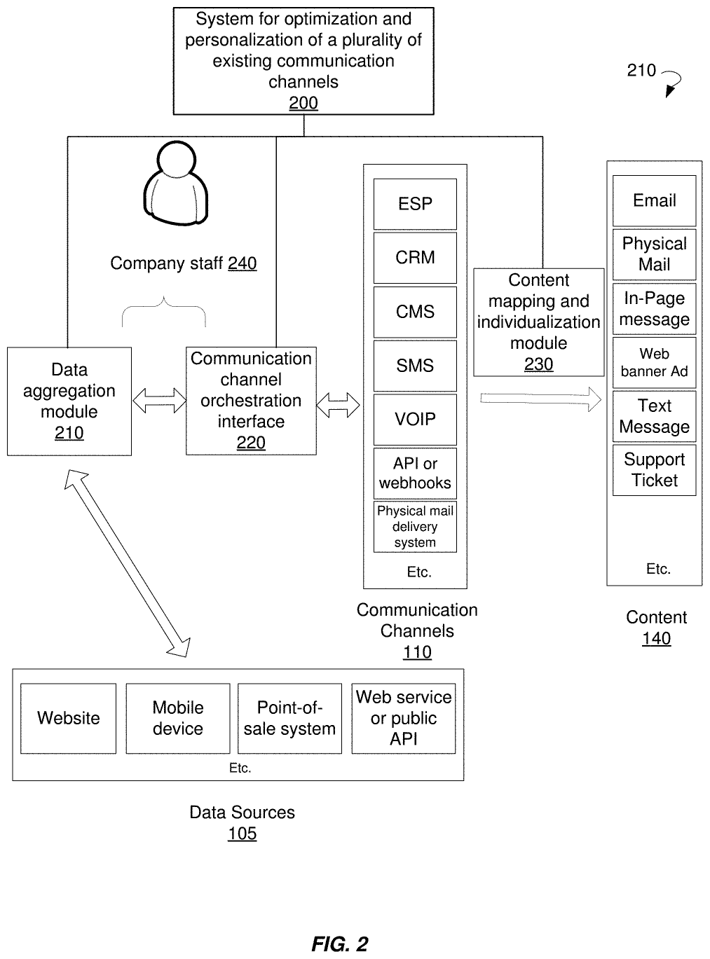

FIG. 2 shows a high-level block diagram illustrating an architecture 210 within which elements of the system for optimization and personalization of a plurality of existing communication channels may be implemented. The system may include a data aggregation module 210, a communication channel orchestration interface 220, and a content mapping and individualization module 230.

The data aggregation module 110 may be configured to collect and aggregate user data from at least one of data sources 105 and generate and maintain end user profiles, which may store all collected and aggregated user data. A vast array of user data associated with a user can be generated or received from a plurality of data sources. In an illustrative embodiment, the received data can include any combination of the following: an Internet Protocol (IP) address, data from user profiles on social networks or other websites, data associated with a location of a user, data obtained from sensors or in other ways from such things as offline stores, kiosks, mobile devices, or point-of-sale systems, data obtained via web services or application programming interfaces (APIs), web hooks, and so on.

Additionally, data associated with users can be generated, for instance, by combining, filtering, or processing the received data in a variety of ways. These ways can include using database retrieval, table lookups, machine learning, and cognitive computing; or augmenting the user data in other ways, such as via publicly available web services or APIs.

To convey a clearer sense of the multitude of kinds of data that can be received or generated, it can be useful to classify some of the more example types of data associated with a user that can be received or generated in accordance with a predetermined taxonomy. Identity data may include data that can be used to distinguish a user from other users, and may be used, for instance, to authenticate a user. Such data can include a name of the user, date of birth, gender, physical mailing address, email address, phone number, social security number, and so on. Operational data may include data that relate to the operation of a device or other machine or entity on which a client application is executed. Such data includes IP or Media Access Control (MAC) addresses, device or machine types, clickstreams, web pages or web sites visited, search keywords used, and so on. Personal data may include data relating to a user that may be used to help identify the user but that are not necessarily unique to the user. Such data may include family information, such as marital status and number of children; lifestyle information, such as the number and kinds of cars owned, the type and size of home, and the number and types of pets; education; profession; financial data, such as income and net worth; other demographic data, such as ethnicity and religion; customer support data; and so on. Preference data may include data that reflects opinions and tastes of the user, such as preferences for types of food or clothing; political affiliation; ratings of books, recordings, or other products; and so on. Situational data may include data related to a situation or environment of the user, such as a time, a date, an entry point, referring campaign, a location, the weather, the time of year or season, and so on. In further example embodiments, other types of data may be received or generated.

Data associated with multiple users from multiple data sources 105 can be automatically aggregated to create multiple user profiles as well as to identify relationships between or among users. Each user profile may store all data collected, aggregated, or generated that are association with a particular user. Moreover, historical data that include patters of past behavior of the user can also be collected. Examples of data sources may include social media, Email Service Provider (ESP) applications (e.g., email), web analytics applications, customer support applications, Customer Relationship Management (CRM) applications, Content Management System (CMS) applications, web advertising applications, point-of-sale systems, mobile tracking technology, other kinds of transmitters or sensors on mobile devices, kiosks, data entered by persons at offline stores, data obtained from web services or publicly accessible or proprietary APIs, and so forth. Examples of relationships between or among multiple users include two or more users being friends on one or more social networks, and one user being married to or a relative of another. Examples of historical data include data associated with a product a user has purchased, a financial history of the user, web sites visited in the past, and so on. Data associated with a particular user may be based on the web sites or web pages the user visits, the offline stores the user goes to, and a wide variety of online or offline events, such as sending an email, sending a search engine request, making a social media post, registering by physical mail, calling customer support, and so on.

The user profiles can be continuously or periodically updated based on data collected from the at least one of data sources 105. In an example embodiment, the user data may be collected by employing web analytics applications in connection with a company's website(s), for instance, by integrating JavaScript snippets, although many other methods for data collection or interception can be used. By default, the systems may integrate JavaScript into a website to automatically create user profiles and personalize the content.

The communication channel orchestration interface 220 may enable a company owner or individual to create or use default business workflows or scenarios for interacting with the users based on available user data. More specifically, the communication channel orchestration interface 220 allows a staff 240 of a company (e.g., marketers or owners) or individuals to create and maintain a business logic for the user interactions of the user via the plurality of existing communication channels. The business logic may be created in the form of predetermined workflows, scenarios, or business rules. The business logic may include a plurality of trigger conditions and a plurality of actions corresponding to the plurality of trigger conditions.

The content mapping and individualization module 230 may map content 140 to the user according to the business logic. The content mapping and individualization module 230 may map content to the user using a recommendation algorithm. Specifically, the content mapping and individualization module 230 may templatize the content to create personalized communication messages for the plurality of existing communication channels.

In an example embodiment, a template for the content may have a plurality of variables, such as a gender, interests, age, products viewed, and so forth, which may make the communication message personalized. An individual template may be created for each communication channel, such as a recommendation section on a website, an email, an SMS, a pop-up message in a mobile application, and so forth.

The content 140 may be delivered to the user via one or more of existing communication channels 110. According to various embodiments, the communication channels 110 may include electronic mailing systems (ESPs), physical mail delivery systems, graphical user interfaces employed on a company's web site, messaging networks (e.g., cellular networks), and so forth. In an example embodiment, the content 140 may be delivered in a form of emails, physical mail, in-page messages, text messages, push notifications for a tablet or other mobile device, web advertising (e.g., banners) or other advertising, telephone voicemail, or any standard visual, auditory, tactile, or haptic message or signal associated with a computing device. For example, the end user may receive a message with the content 140 via an interface associated with the website of the company, via CRM, CMS, an ESP, a physical mail system, an SMS or other text messaging system, a telephony system, a voice-over-IP (VOIP) system, a graphical user interface, any API accessible to communicate with the end user, or any computing output device known to one of ordinary skill in the art, such as a monitor, speaker, network card, or touch or haptic interface. The content 140 may include an email, physical mail, customer support tickets, in-page messages, web advertising (e.g., banner ads) or other advertising, text messages, push notifications for a tablet or other mobile device, telephone voicemail, or any visual, auditory, tactile, or haptic message or signal associated with a standard computing device as is known to one of ordinary skill in the arts.

In some example embodiments, the communication channels 110 may employ some components of a customer support center to allow the content mapping and individualization module 230 to generate the content 140 in a form of a customer support ticket for further resolution of the problem by appropriate personnel.

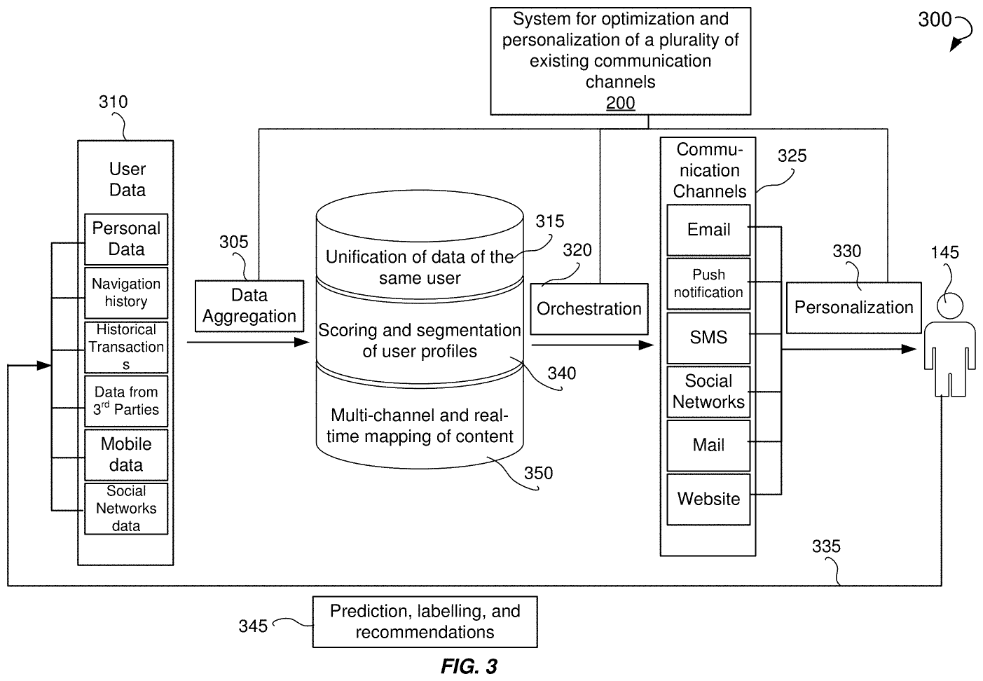

FIG. 3 is a schematic diagram 300 illustrating operation of the system for optimization and personalization of a plurality of existing communication channels, according to an example embodiment. The system may include a data aggregation module configured to perform data aggregation 305 by aggregating user data 310 received from a plurality of data sources. The user data may be associated with at least one user. In an example embodiment, the data aggregation module be further configured to prioritize the user data using a ranking algorithm.

The user data related to one or more users may include personal data, such as email addresses, names, physical addresses, phone numbers, and the like. The user data may further include navigation history of the user that may include interactions of the user with a web site or a mobile application of a company. Other examples of user data include historical transactions of the users, which may include products and services bought by the user on the web site or the mobile application of the company. The user data may further include mobile data collected by using functionalities and a software development kit (SDK) of the system, social network data of the user, and data received from third parties.

The data sources may include one or more of the following: user demographics data, location data, gender data, purchase data, content viewed, items purchased, a location, weather, an organization, preferences, an income, historical interactions, third party data, CRM data, Data Management Platform (DMP) data, existing emails, feedback received in response to the user interactions, screen data, personal data, navigation data, historical transactions, a lifestyle, technology used, and so forth.

In an example embodiment, the user data may be collected to feed the user profile from a website using a Java Script and may be collected from a mobile application using an SDK. The Java Script and SDK may also be used to show the content directly on the website and mobile application. The SDK can also be used to display in-app and push notifications. These functionalities create a first party technology part of the system for optimization and personalization of existing communication channels.

The data aggregation module may be further configured to create at least one user profile for the at least one user based on the aggregated user data 310. Specifically, the data aggregation module may perform unification 315 of data related to the same user. The data related to the same user may be stored in the user profile. The user profile may include an anonymous user profile associated with an anonymous user. The user profile may further include an identified user profile associated with an identified user that used user credential to login into a website or an application.

In an example embodiment, the data aggregation module may perform scoring and segmentation 340 of user profiles. Specifically, the user profiles may be scored and/or segmented into segments/clusters based on predetermined criteria. Upon clustering the users based on identical or similar attributes in the user data, the same communication message may be sent to the users in the cluster but the content may be adapted individually for each user in the cluster according to key attributes tracked in the user profile. In an example embodiment, the user 145 may include a segment of users selected based on scoring of the user profiles or selected based on predetermined criteria.

The system may further include a communication channel orchestration interface configured to manage a plurality of existing communication channels. Specifically, the communication channel orchestration interface may create a business logic for user interactions of the at least one user via a plurality of existing communication channels 325. The business logic may include a plurality of trigger conditions and a plurality of actions corresponding to the plurality of trigger conditions. The existing communication channels 325 may include an email, a mobile application, push notifications, SMS, social network messaging or posting, a website, a customer support ticket, and printed mail, and so forth.

The system may further include a content mapping and individualization module configured to perform personalization 330 of content for a user 145. Specifically, the content mapping and individualization module may be configured to map, using a recommendation algorithm, the content to the at least one user 145 according to the business logic. In an example embodiment, the recommendation algorithm may include one or more of the following: an algorithm created by developers of the system (a first party technology), an algorithm created by a third party, a product data feed (which contains product information), a machine learning algorithm, and so forth. In some example embodiments, the recommendation algorithm may be further configured to predict user behavior associated with the at least one user using machine learning techniques.

For example, for an A/B test, a percentage users to be exposed to the system may be selected, e.g., 50% with the remaining 50% being in a control group not exposed to the system. Thus, the system may personalize the existing communication channels of a customer for 50% of users of the existing communication channels. The result of the test can be a demonstration of an increase in conversions for the communication channel achieved based on the exposure of the users of the communication channel to the system.

The content mapping and individualization module may templatize the content to create personalized communication messages for the user 145. The content mapping and individualization module may also perform multi-channel and real-time mapping 350 of the content to the user 145 by delivering the personalized communication messages to the user 145 using one or more of the plurality of existing communication channels 325 in real time. The content mapping and individualization module may be further configured to index content, ecommerce content, and plain content.

The data aggregation module is configured by default to receive feedback data 335 in response to user interactions with the personalized communication messages. In an example embodiment, the user interactions may include one or more of clicks, purchases, webpages visited by the user, and so forth. Based on the feedback data 335, the data aggregation module may update the at least one user profile with the feedback data 335. The data aggregation module may further update the recommendation algorithm and a next suggestion communication action (e.g., which type of communication needs to be sent to the user, by which communication channel the communication needs to be sent, what content to use for the communication, how to personalize the content for the user, and so forth) based on the at least one updated user profile. The data aggregation module may further use the feedback data 335 for prediction of user interactions, labeling the user (e.g., identifying the user to be a frequent customer, a baby boomer, a millennial, a social traffic user, and so forth), and selecting recommendations 345 (e.g., how the content needs to be personalized) for the user.

The feedback data 335 may show when an email sent to the user was opened, which links the user clicked, whether the user opened the website linked in the email, and so forth. The feedback data 335 may be stored to the user profile for personalizing further content (e.g., further email) and for selection of communication channels for further communications with the user (e.g., if the user never opens emails, another communication channel b can be selected for further communications with the user).

The data aggregation module may be further configured to enrich the user data using an Artificial Intelligence (AI) technique. In some example embodiments, the data aggregation module may be further configured to combine several data sources of the plurality of data sources for predicting user behavior associated with the at least one user, clustering users, or for other purposes.

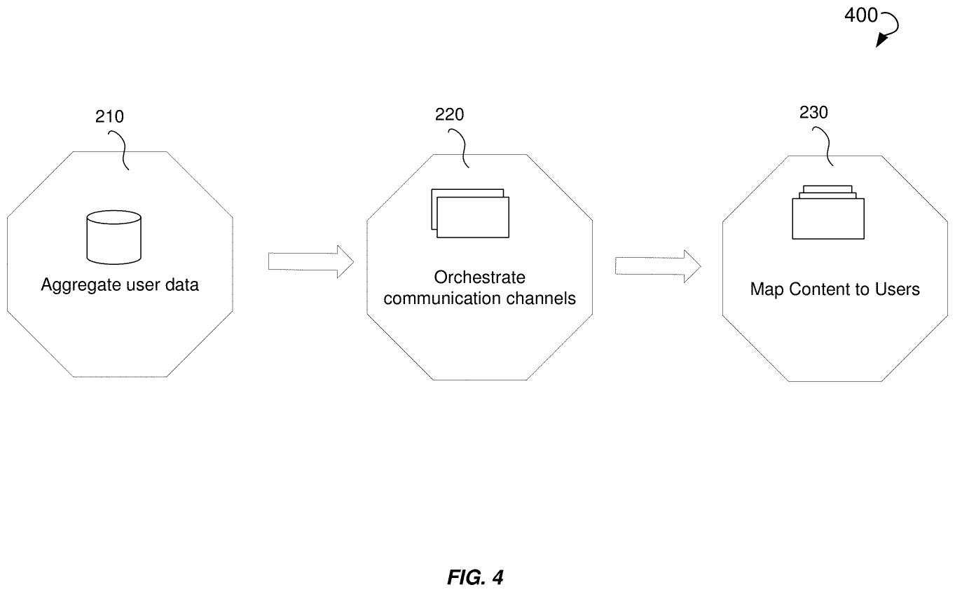

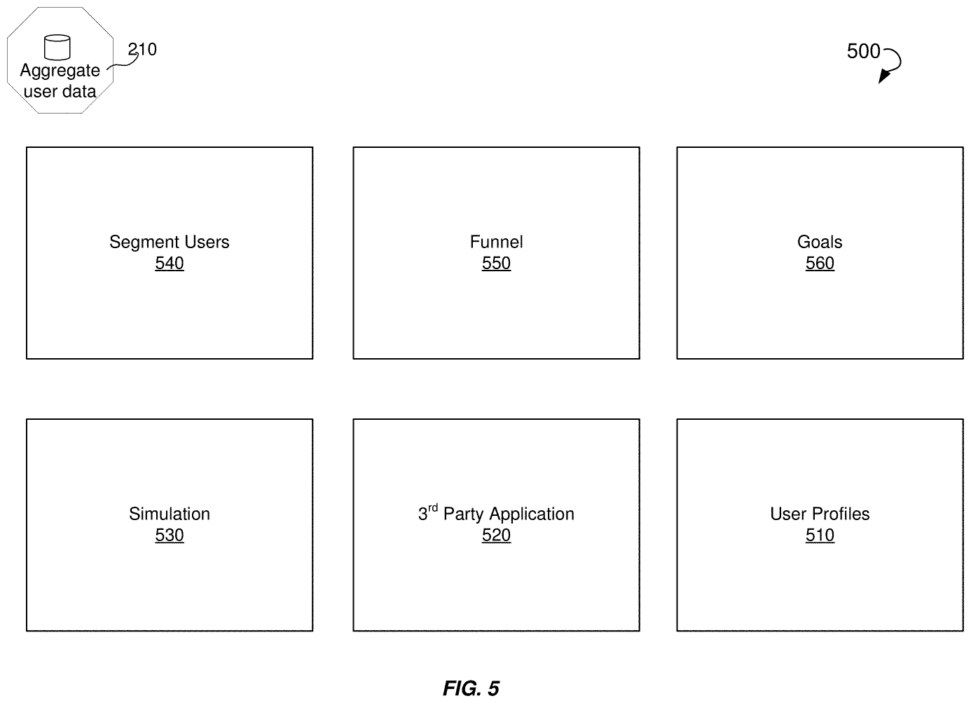

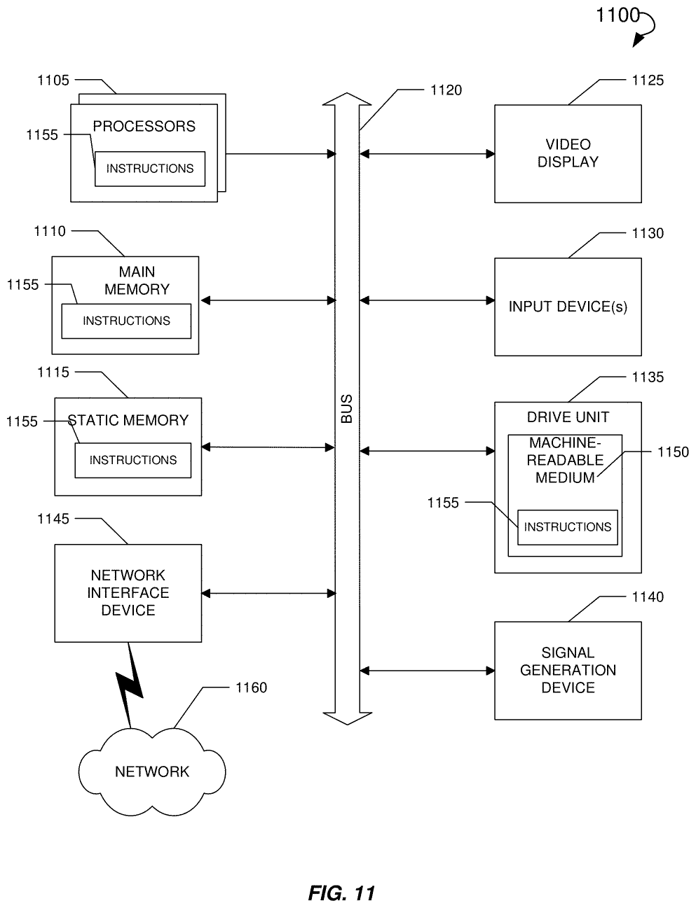

FIG. 4 is a schematic diagram 400 showing three key components of the system for optimization and personalization of a plurality of existing communication channels, according to an example embodiment. The system includes a data aggregation module 210 for aggregating user data, a communication channel orchestration interface 220 for orchestration of communication channels, and a content mapping and individualization module 230 for mapping content to users. The operations performed by the components of the system are shown in detail with reference to FIGS. 5-9. Each of the data aggregation module 210, the communication channel orchestration interface 220, and the content mapping and individualization module 230 may include a processor and a memory in communication with the processor and storing instructions executable by the processor. A system within which a set of instructions may be implemented in described in more detail below with reference to FIG. 11.

FIG. 5 is a schematic diagram 500 illustrating key components included into a data aggregation module 210, according to an example embodiment. Upon collection of user data from multiple data sources, the data aggregation module 210 may create user profiles 510. The user profile may be anonymous if associated with a user that visited a website or an application without logging and identified if associated with a user that used user credentials to login into the website or the application. The data aggregation module 210 may further connect to a third party application 520 to enrich the user data.

In an example embodiment, the data aggregation module 210 may use the user data to simulate scenarios of personalizing the content to be sent to the user and user interactions in response to receiving the content. The data aggregation module 210 may use the user data to segment users into groups and send personalized content to groups of users. The data aggregation module 210 may further create funnels 550 to develop a path of the user to the purchase of a good or service. The funnels 550 may have a condition (e.g., clicking by the user on the content) and a goal (e.g., purchasing goods or services associated with the content by the user). The data aggregation module 210 may further set goals 560, e.g., a percentage of users that interacted with the content, a percentage of users that purchased goods or services associated with the content, and so forth.

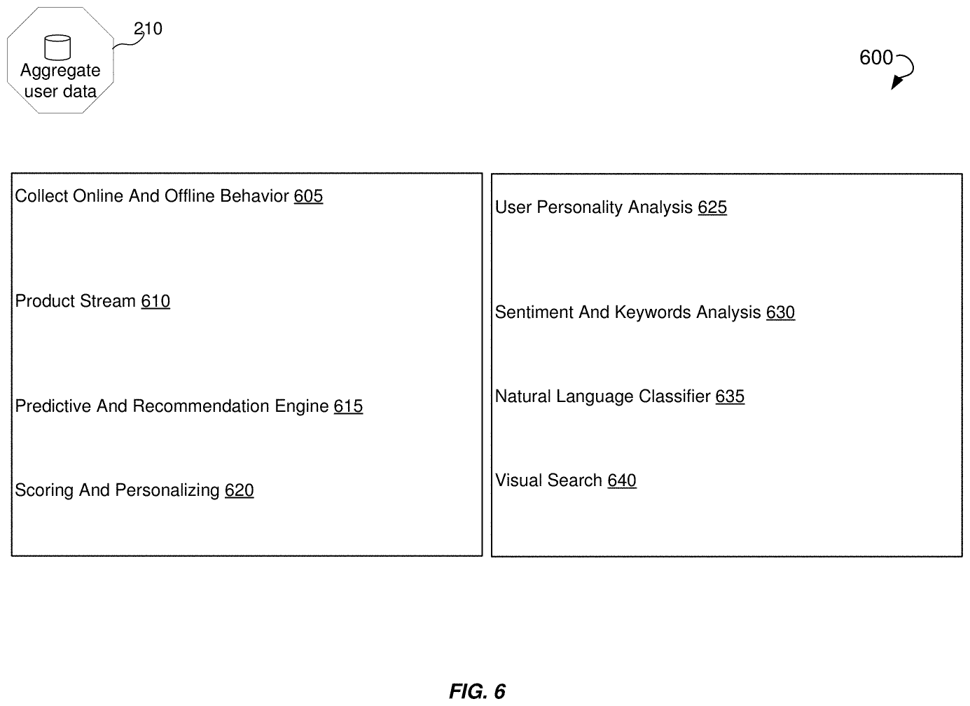

FIG. 6 is a schematic diagram 600 showing key components included into a data aggregation module 210 associated with both quantitative information (left) and qualitative information such as Artificial Intelligence (right), according to an example embodiment. In an example embodiment, the data aggregation module 210 may use the artificial intelligence in analyzing the user data. The data aggregation module 210 may collect data related to online and offline behavior 610 of the user, create a product stream 610 for content associated with products of a customer, and use a predictive and recommendation engine 615 to predict user behavior and provide recommendations for personalizing the content for the user. The data aggregation module 210 may further score user data and personalize the content based on the scored data.

In further example embodiments, the data aggregation module 210 may perform user personality analysis 625 based on the collected user data. The user data may also be used to perform sentiment and keywords analysis 630. The sentiment and keywords analysis 630 may be performed, for example, based on user data collected from user profiles in social networks. The data aggregation module 210 may further use a natural language classifier 635 to analyze the language of the collected user data. The data aggregation module 210 may collect data related to visual search 640 when multiple recommended products are visually provided to the user in recommendations.

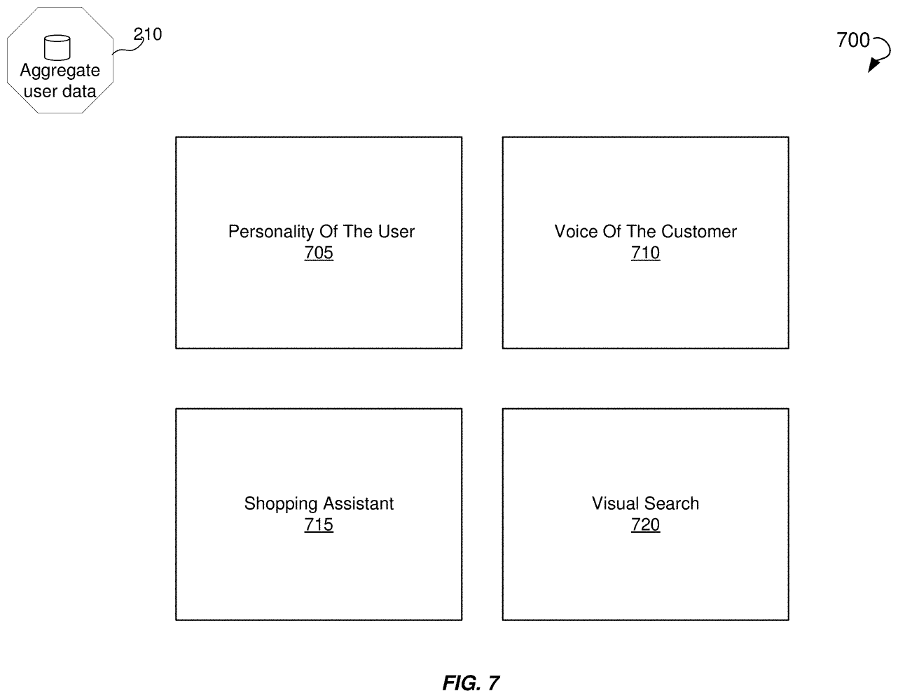

FIG. 7 is a schematic diagram 700 showing key components included into a data aggregation module 210 associated with Artificial Intelligence, according to an example embodiment. The aggregation module 210 may analyze user data and predict a personality 705 of the user. For example, the aggregation module 210 may analyze pages visited by the user and purchases made by the user and determine that the user is, for example, a male aged 25-30 having a pet.

In an example embodiment, the aggregation module 210 may analyze voice 710 of the user. The voice 710 of the user may include, for example, an opinion of the user with respect to a brand (positive or negative).

The aggregation module 210 may further provide a shopping assistant 715 for the user and analyze the user interactions with the shopping assistant 715, such as which suggestions the user accepts or denies. The aggregation module 210 may further provide a visual search 720 for the user and visually show recommended products. The aggregation module 210 may analyze the user interactions with products provided in the visual search.

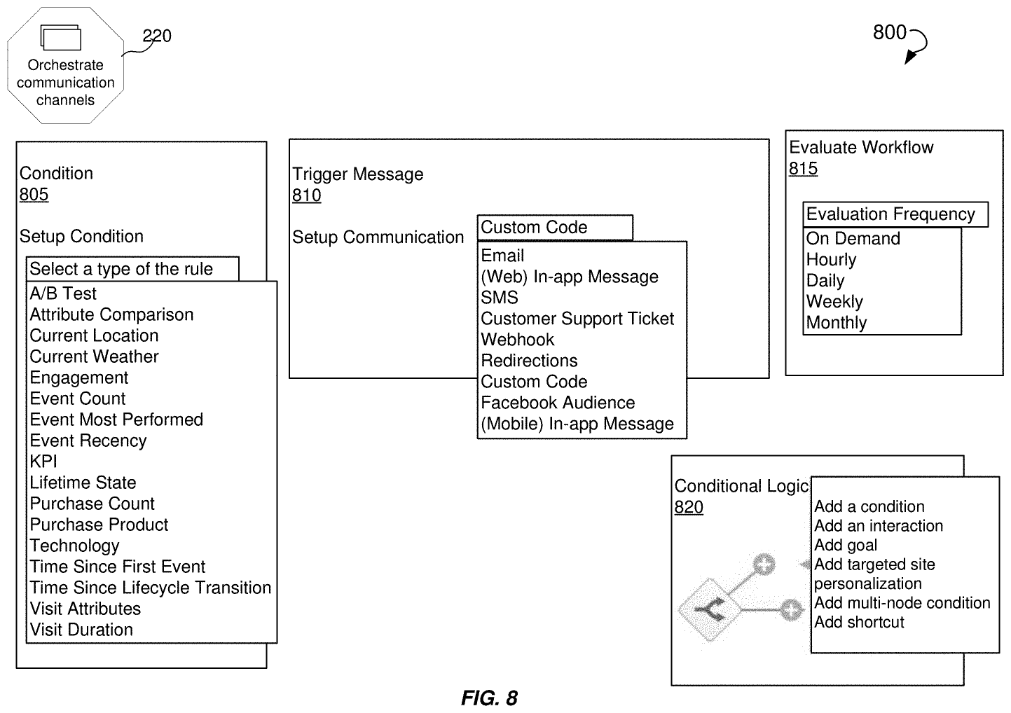

FIG. 8 is a schematic diagram 800 showing steps performed by the communication channel orchestration interface 220, according to an example embodiment. To orchestrate different communications channels, multiple trigger conditions 805 (rules) can be set using the communication channel orchestration interface 220. The trigger conditions 805 may include an A/B test, attribute comparison, current location of the user, current weather at the location of the user, engagement of the user, event count, event most performed, event recency, key performance indicators, lifetime state, purchase count, purchase product, technology, time since first event, time since lifecycle transition, visit attributes, visit duration and so forth.

For each of trigger conditions 805, one or more messages 810 to be triggered upon occurring a trigger condition 805 may be selected. The triggering of the messages 810 may include sending a communication to the user using a selected communication channel, such as an email, (web) in-app message, SMS, customer support ticket, webhook, redirections, custom code, Facebook audience, (mobile) in-app message, and so forth.

The workflow 815 of communicating with the user using the communication channels may be evaluated on demand or on a periodic basis, e.g., hourly, daily, weekly, monthly, and so forth.

The communication channel orchestration interface 220 may further use a conditional logic 820 and add any of a condition, an interaction, a goal, a targeted site personalization, a multi-node condition, and a shortcut to the business logic for the user interactions of the at least one user via the plurality of existing communication channels.

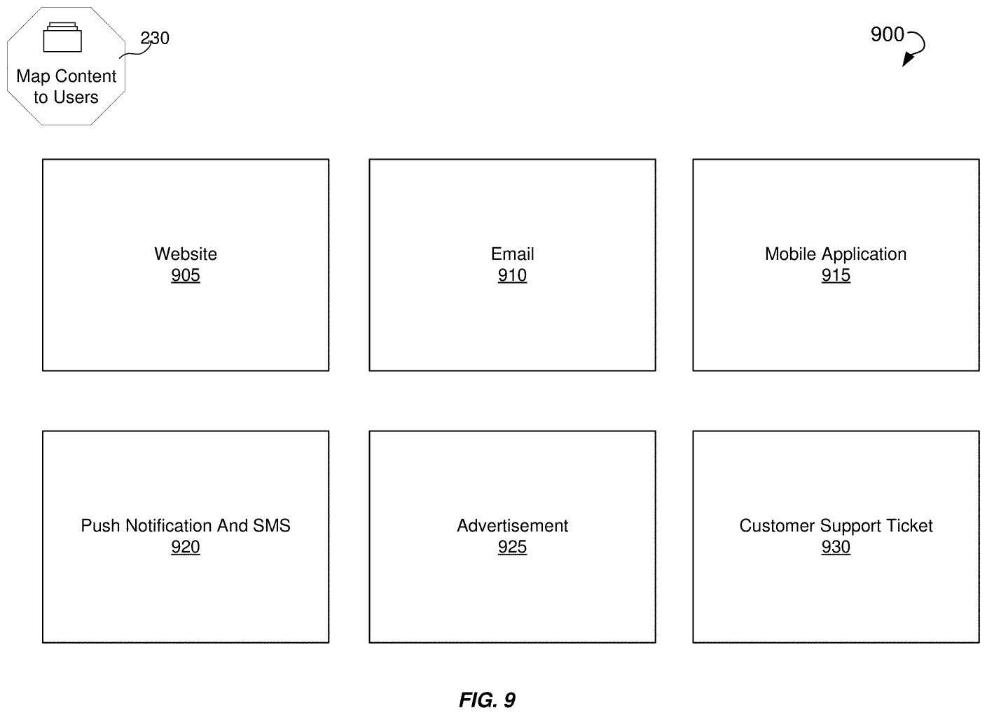

FIG. 9 is a schematic diagram 900 showing steps performed by the content mapping and individualization module 230, according to an example embodiment. The content mapping and individualization module may map personalized content to the user according to the business logic. The content may be provided to the user using one of communication channels, such as a website 905, an email 910, a mobile application, a push notification and SMS 920, an advertisement 925, a customer support ticket 930, and so forth.

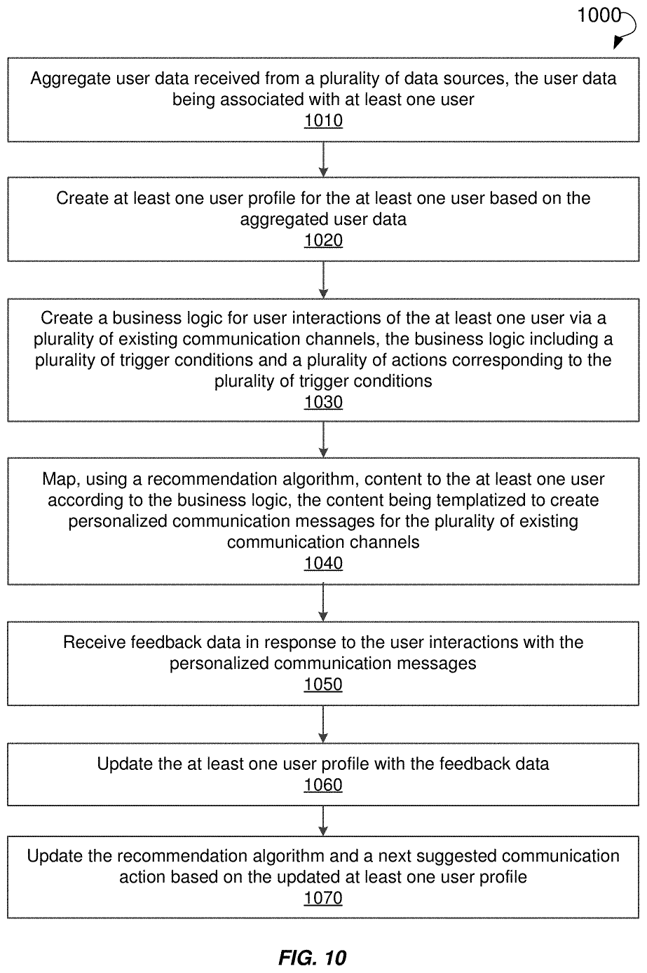

FIG. 10 is a flow diagram that shows a method 1000 for optimization and personalization of a plurality of existing communication channels. The method 1000 can be performed by processing logic that may be implemented in hardware (e.g., dedicated logic, programmable logic, or microcode), software (such as software run on a general-purpose computer system or a dedicated machine), or a combination of both. In one example embodiment, the processing logic is collocated with the data aggregation module 210, the communication channel orchestration interface 220, and the content mapping and individualization module 230 (for instance, they may all execute on the same server).

The method 1000 can commence at operation 1010 with aggregating user data received from a plurality of data sources. The user data being associated with at least one user. The method 1000 may continue with creating at least one user profile for the at least one user based on the aggregated user data at operation 1020. In some example embodiments, the method 1000 may include prioritizing the user data using a ranking algorithm. The method 1000 may further include combining several data sources of the plurality of data sources for predicting user behavior associated with the at least one user and/or clustering users.

In an example embodiment, the method 1000 may further include predicting user behavior associated with the at least one user using machine learning techniques. The prediction may be based on the user data. Data related to prediction may be added to the user profile.

The method 1000 may further include creating a business logic for user interactions of the at least one user via the plurality of existing communication channels at operation 1030. The business logic may include a plurality of trigger conditions and a plurality of actions corresponding to the plurality of trigger conditions.

The method 1000 may continue with mapping content to the at least one user according to the business logic at operation 1040. The mapping may be performed using a recommendation algorithm. The content may be templatized to create personalized communication messages for the plurality of existing communication channels. The method 1000 may further include indexing content, ecommerce content, and plain content.

The method 1000 includes receiving feedback data by default in response to the user interactions with the personalized communication messages at operation 1050. The at least one user profile is updated with the feedback data at operation 1060. The recommendation algorithm and the next suggested communication action may be updated based on the at least one updated user profile at operation 1070. In some example embodiments, the method 1000 may include enriching the user data using an AI.

FIG. 11 shows a diagrammatic representation of a computing device or a machine in, for example, the electronic form of a computer system 1100, within which a set of instructions for causing the machine to perform any one or more of the methodologies discussed herein can be executed. In some embodiments, the machine operates as a standalone device, while in other embodiments it can be connected (e.g., networked) to other machines. In a networked deployment, the machine can operate in the capacity of a server, a client machine in a server-client network environment, or as a peer machine in a peer-to-peer (or distributed) network environment. The machine can be or comprise a personal computer (PC), tablet PC, cellular telephone, web appliance, network router, switch, bridge, or any machine capable of executing a set of instructions (sequential or otherwise) that specify actions to be taken by that machine. Further, while only a single machine is illustrated, the term “machine” shall also be taken to include any collection of machines that separately or jointly execute a set (or multiple sets) of instructions to perform any one or more of the methods discussed herein.

In an illustrative embodiment, the computer system 1100 comprises at least one processor 1105 (e.g., a central processing unit (CPU), a graphics processing unit (GPU), and so on, singly or in combination), and a memory, which in this example comprises a main memory 1110 and a static memory 1115. The computer system 1100 may further comprise a video display 1125, a signal generation device 1140 (e.g., a speaker), and a network interface device 1145. In addition, the computer system 1100 may comprise at least one input device 1130, such as an alphanumeric input device (e.g., a keyboard), a cursor control device (e.g., a mouse), a microphone, a digital camera, and so forth. Communication among the components may be accomplished via a bus 1120. It will be apparent to one of ordinary skill in the art that the computer system 1100 can be implemented in a variety of ways—to give just one example, a speech processing system can be used in place of the video display unit 1125 and input device 1130.

A drive unit 1135 includes a computer-readable medium 1150, which stores one or more sets of instructions 1155 and data embodying or utilized by any one or more of the methods or functions described herein. The instructions 1155 can also reside, completely or at least partially, within the main memory 1110 and/or within the processors 1105 during execution thereof by the computer system 1100. The main memory 1110 and the processors 1105 also constitute machine-readable media.

The instructions 1155 can further be transmitted or received over a communications network 1160 via the network interface device 1145 utilizing any one of a number of well-known transfer protocols (e.g., Hyper Text Transfer Protocol (HTTP), CAN, Serial, and Modbus). The communications network 1160 may include the Internet, local intranet, PAN (Personal Area Network), LAN (Local Area Network), WAN (Wide Area Network), MAN (Metropolitan Area Network), virtual private network (VPN), a cellular network, Bluetooth radio, or an IEEE 802.11-based radio frequency network, and the like.

While the computer-readable medium 1150 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methods of the present application, or that is capable of storing, encoding, or carrying data utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions installed on a computer, in software, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written utilizing any number of suitable programming languages such as, for example, HyperText Markup Language (HTML), Dynamic HTML, Extensible Markup Language, Extensible Stylesheet Language, Document Style Semantics and Specification Language, Cascading Style Sheets, Synchronized Multimedia Integration Language, Wireless Markup Language, Java™, Jini™, C, C++, C#, .NET, Adobe Flash, Perl, UNIX Shell, Visual Basic or Visual Basic Script, Virtual Reality Markup Language, ColdFusion™ Objective-C, Scala, Clojure, Python, JavaScript, HTML5 or other compilers, assemblers, interpreters, or other computer languages or platforms, as one of ordinary skill in the art will recognize.

Thus, systems and methods for optimization and personalization of existing communication channels have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A system for optimization and personalization of a plurality of existing communication channels, the system comprising:
a data aggregation module configured to:
aggregate user data received from a plurality of data sources, the user data being associated with at least one user;
create at least one user profile for the at least one user based on the aggregated user data;
receive feedback data in response to user interactions with the personalized communication messages;
update the at least one user profile with the feedback data; and
update a recommendation algorithm and a next suggestion communication action based on the at least one updated user profile;
a communication channel orchestration interface configured to create a business logic for the user interactions of the at least one user via the plurality of existing communication channels, the business logic including a plurality of trigger conditions and a plurality of actions corresponding to the plurality of trigger conditions; and
a content mapping and individualization module configured to map, using the recommendation algorithm, content to the at least one user according to the business logic, the content being templatized to create personalized communication messages for the plurality of existing communication channels.

2. The system of claim 1, wherein the user interactions include one or more of clicks on content or purchases.

3. The system of claim 1, wherein the at least one user profile includes one of an anonymous user profile and an identified user profile.

4. The system of claim 1, wherein the plurality of data sources include one or more of the following: user demographics data, location data, weather data, gender data, purchase data, content viewed, items purchased, a location, weather, an organization, preferences, an income, historical interactions, third party data, Customer Relationship Management (CRM) data, Data Management Platform (DMP) data, existing emails, feedback received in response to the user interactions, screen data, personal data, navigation data, historical transactions, a lifestyle, or information provided by a third party and technology used.

5. The system of claim 1, wherein at least a portion of the user data is collected from a website using a Java Script or from a mobile application using a software development kit (SDK).

6. The system of claim 1, wherein the plurality of existing communication channels includes one or more of the following: a website, a mobile application, an email, a Short Message Service (SMS), a push notification, a customer support ticket, and printed mail.

7. The system of claim 1, wherein the content mapping and individualization module is further configured to index one or more of the following: content, ecommerce content, and plain content via a product or content data feed listing all the possible information available for optimizing and personalizing the content for each user based on the recommendation algorithm and user profile.

8. The system of claim 1, wherein the recommendation algorithm includes one or more of the following: an algorithm integrated into the system or an algorithm created by a third party.

9. The system of claim 1, wherein the at least one user includes a segment of users selected based on scoring of the at least one user profile or based on predetermined criteria.

10. The system of claim 1, wherein the recommendation algorithm is further configured to predict user behavior associated with the at least one user using machine learning techniques.

11. The system of claim 1, wherein the data aggregation module is further configured to prioritize the user data using a ranking algorithm.

12. The system of claim 1, wherein the data aggregation module is further configured to enrich the user data using an artificial intelligence (AI).

13. The system of claim 1, wherein the data aggregation module is further configured to combine several data sources of the plurality of data sources for one or more of the following: predicting user behavior associated with the at least one user and clustering users.

14. A method for optimization and personalization of a plurality of existing communication channels, the method comprising:
aggregating user data received from a plurality of data sources, the user data being associated with at least one user;
creating at least one user profile for the at least one user based on the aggregated user data;
creating a business logic for user interactions of the at least one user via the plurality of existing communication channels, the business logic including a plurality of trigger conditions and a plurality of actions corresponding to the plurality of trigger conditions;
mapping, using a recommendation algorithm, content to the at least one user according to the business logic, the content being templatized to create personalized communication messages for the plurality of existing communication channels;
receiving feedback data in response to the user interactions with the personalized communication messages;
updating the at least one user profile with the feedback data; and
updating the recommendation algorithm and a next suggestion communication action based on the updated at least one user profile.

15. The method of claim 14, further comprising predicting user behavior associated with the at least one user using machine learning techniques.

16. The method of claim 14, further comprising enriching the user data using an artificial intelligence (AI) technique.

17. The method of claim 14, further comprising combining several data sources of the plurality of data sources for one or more of the following: predicting user behavior associated with the at least one user and clustering users.

18. The method of claim 14, further comprising prioritizing the user data using a ranking algorithm.

19. The method of claim 14, further comprising indexing one or more of the following: content, ecommerce content, and plain content.

20. A system for optimization and personalization of a plurality of existing communication channels, the system comprising:
a data aggregation module configured to:
aggregate user data received from a plurality of data sources, the user data being associated with at least one user;
create at least one user profile for the at least one user based on the aggregated user data;
enrich the user data using an artificial intelligence (AI);
receive feedback data in response to user interactions of the at least one user with personalized communication messages;
update the at least one user profile with the feedback data; and
update a recommendation algorithm and a next suggestion communication action based on the at least one updated user profile, wherein the recommendation algorithm is further configured to predict user behavior associated with the at least one user using machine learning techniques, wherein the recommendation algorithm includes one or more of the following: an algorithm created by developers associated with the system, an algorithm created by a third party, and a product data feed;
a communication channel orchestration interface configured to create a business logic for the user interactions of the at least one user via the plurality of existing communication channels, the business logic including a plurality of trigger conditions and a plurality of actions corresponding to the plurality of trigger conditions; and
a content mapping and individualization module configured to map, using the recommendation algorithm, content to the at least one user according to the business logic, the content being templatized to create the personalized communication messages for the plurality of existing communication channels.
